(19) United States
(12) Patent Application Publication
(10) Pub. No.: US 2015/0371580 A1
(43) Pub. Date: Dec. 24, 2015

(54) DISPLAY APPARATUS, AND DRIVING METHOD OF DISPLAY APPARATUS

(71) Applicant: SHARP KABUSHIKI KAISHA, Osaka-shi, Osaka (JP)

(72) Inventors: Masafumi YASHIKI, Osaka-shi (JP); Tomoyuki ISHIHARA, Osaka-shi (JP); Masamitsu KOBAYASHI, Osaka-shi (JP)

(21) Appl. No.: 14/765,856

(22) PCT Filed: Oct. 7, 2013
(86) PCT No.: PCT/JP2013/077240

§ 371 Date: Aug. 5, 2015

(30) Foreign Application Priority Data
Feb. 6, 2013 (JP) 2013-021519

(51) Int. Cl. G09G 3/20

(52) U.S. Cl. CPC G09G 3/2003; G09G 2320/0666

(57) ABSTRACT

A display apparatus, and a driving method of driving the display apparatus control color breakup and prevent flicker. A backlight periodically emits a light beam by lighting one type of light source in a subframe period and a light beam by lighting all types of light sources in a subsequent subframe period. A lighting period for a cycle of emission of the same type of color light beams is shorter than a period for a cycle of receiving the video signal.

### BACKGROUND OF THE INVENTION

1. Field of the Invention

The present invention relates to a display apparatus, and a driving method of the display apparatus.

2. Description of the Related Art

A field sequential driving method is known as a driving method of a display apparatus to display a color video. FIG. 7 is a timing diagram illustrating such field sequential driving. A display apparatus that uses the field sequential driving method includes a liquid-crystal panel, and a backlight having light sources of R, G, and B, and segments a frame period into three subframe periods. The display apparatus controls each light source in a lighting operation and the liquid-crystal panel in synchronization with each subframe period to display three subframe videos. The three subframe videos are overlaid on the retinas of a viewer through the residual image effect, and the viewer then recognizes the three subframe videos as one frame video.

If the frame frequency is 60 Hz, the drive frequency of the light sources that are driven during the three subframe periods is 180 Hz. In view of the light source of one color only, however, the drive frequency of the light source of that color is 60 Hz. If the lighting operation of the light source is controlled at 70 Hz or lower, the viewer typically recognizes the video as a flicker.

The field sequential driving display apparatus suffers from flicker responsive to the drive frequency of each color light source if single color light sources, such as RGB light sources, are used as a backlight.

Japanese Unexamined Patent Application Publication No. 2007-206698 discloses a driving method of a field sequential video display apparatus that uses RGB monochromatic light sources. The field sequential video display apparatus segments a frame of a video signal into multiple fields (subframes) at least higher in number than the number of types of monochromatic light sources, and sets an average drive frequency of each of the monochromatic light sources to be higher than a frame rate. FIG. 8 illustrates a driving method of the field sequential video display apparatus of Japanese Unexamined Patent Application Publication No. 2007-206698.

The video signal has a frame rate of 60 Hz, and each of the R, G, and B light sources are driven by seven times over three consecutive frames, and is thus lit for a period of 7.14 ms on average. This duration of time, if converted into an average driving frequency, is 140 Hz. Since the R, G, B light sources are driven at a frame rate higher than the standard 60 Hz, the occurrence of flicker is reduced.

By displaying a W (white) image in a subframe in each frame, the color breakup caused by the shifting of a moving video is reduced.

Japanese Patent No. 3690159 discloses an image processing apparatus that includes a display location correction circuit that corrects a display location of each subframe in each frame using a motion detector circuit. In response to the amount of movement of a detected image, the image processing apparatus disclosed in Japanese Patent No. 3690159 moves a green image by one-third of the amount of movement, and a blue image by two-thirds of the amount of movement.

Since the subframe displaying a W video is repeated at a frequency of 60 Hz in the driving method of the field sequential video display apparatus of Japanese Unexamined Patent Application Publication No. 2007-206698, the viewer may recognize lighting of the W light source at 60 Hz (lighting of R, G, and B light sources) as flicker.

The image processing apparatus of Japanese Patent No. 3690159 has a lighting frequency of each color light source of Hz, and thus suffers from flicker. Japanese Patent No. 3690159 does not disclose a correction method that is to be performed in a case that a frame is divided into multiple fields in number greater than the number of types of monochromatic light sources, and that the average drive frequency in each of the monochromatic light source is set to be higher than the frame rate.

### SUMMARY OF THE INVENTION

Display apparatuses and driving methods according to various preferred embodiments of the invention have been developed to address the above problem. Preferred embodiments of the present invention provide display apparatuses and driving methods that control color breakup while preventing flicker.

According to a preferred embodiment of the present invention, a display apparatus includes a light source including a plurality of types of light sources that respectively emit different color light beams, a display panel that displays a video by allowing the color light beams emitted from the light source to be transmitted therethrough, and a subframe data generator that generates a display control signal that controls an operation of the light source and the display panel in response to video signals consecutively input from the outside. The subframe data generator segments a period for a cycle of receiving the video signal into a plurality of subframe periods, and generates the display control signal that controls the operation of the light source and the display panel during each subframe period in response to the video signal. In response to the display control signal, the light source periodically alternates between a light beam emitted by one type of the light sources in a subframe period and the light beams emitted by all the types of the light sources in a subsequent subframe period. In view of each type of the color light beams emitted from the light source, a lighting period for a cycle of emission of the same type of color light beams is shorter than the period for the cycle of receiving the video signal.

There is provided a driving method of a display apparatus according to another aspect of various preferred embodiments of the present invention. The display apparatus according to the present preferred embodiment includes a light source including a plurality of types of light sources that respectively emit different color light beams, and a display panel that displays a video by allowing the color light beams emitted from the light source to be transmitted therethrough. The driving method displays in response to video signals consecutively input from the outside, and includes a step of segmenting a period for a cycle of receiving the video signal into a plurality of subframe periods, and controlling an operation of the light source and the display panel during each subframe period in response to the video signal. In the step, the light source periodically alternates between a light beam emitted by one type of the light sources in a subframe period and the light beams emitted by all the types of the light sources in a subsequent subframe period. In view of each type of the color light beams emitted from the light source, the operation of the light source is controlled in a manner such that a lighting period for a cycle of emission of the same type of color light beams is shorter than the period for the cycle of receiving of the video signal.

According to various aspects of preferred embodiments of the present invention, display apparatuses and driving methods that control color breakup while preventing flicker.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating a display apparatus of a first preferred embodiment of the present invention.

FIG. 2 is a timing diagram illustrating an operation of the display apparatus of the first preferred embodiment of the present invention.

FIG. 3 is a timing diagram illustrating the operation of the display apparatus of the first preferred embodiment of the present invention.

FIG. 4 is a timing diagram illustrating the operation of the display apparatus of a second preferred embodiment of the present invention.

FIGS. 5A and 5B illustrate how an object moving on a display screen is visually recognized by a viewer wherein FIG. 5A illustrates how the object on a field sequential driving display apparatus of the related art is visually recognized by the viewer, and FIG. 5B illustrates how the object is visually recognized by the viewer if position correction of a preferred embodiment of the present invention is applied.

FIG. 6 is a block diagram illustrating a display apparatus of a third preferred embodiment of the present invention.

FIG. 7 is a timing diagram illustrating the field sequential drive of the related art.

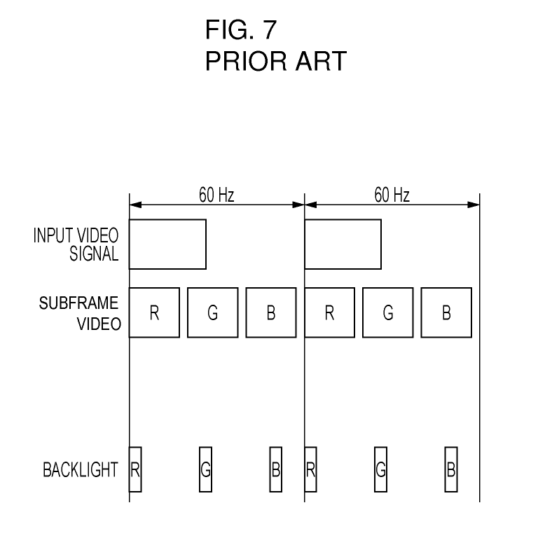

FIG. 8 illustrates a driving method of a field sequential video display apparatus disclosed in Japanese Unexamined Patent Application Publication No. 2007-206698.

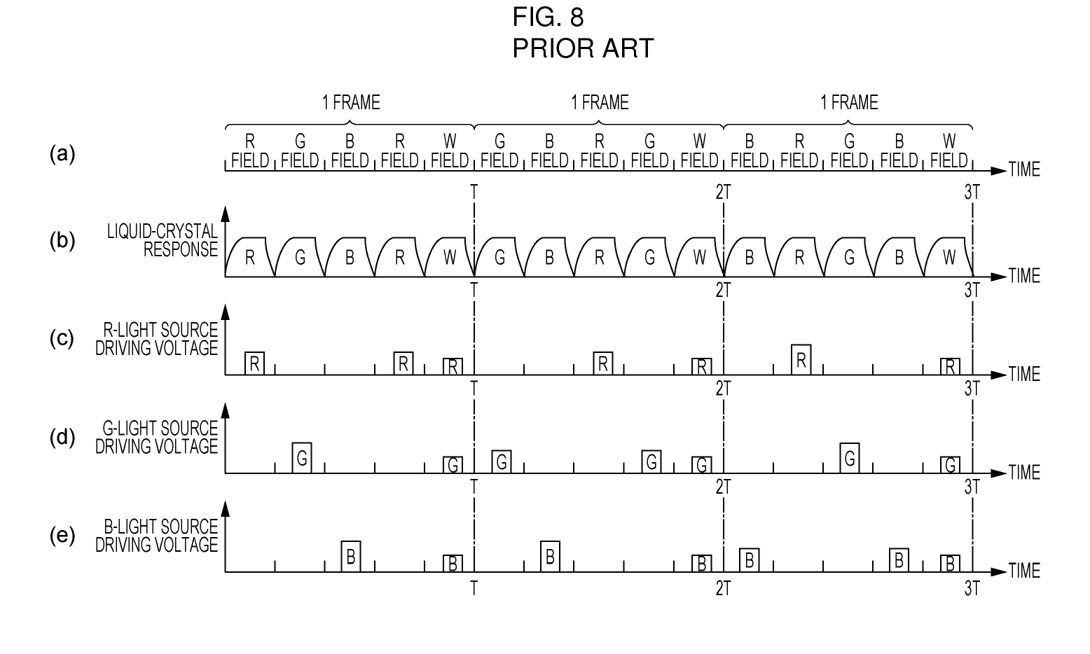

### DETAILED DESCRIPTION OF THE PREFERRED EMBODIMENTS

### First Preferred Embodiment

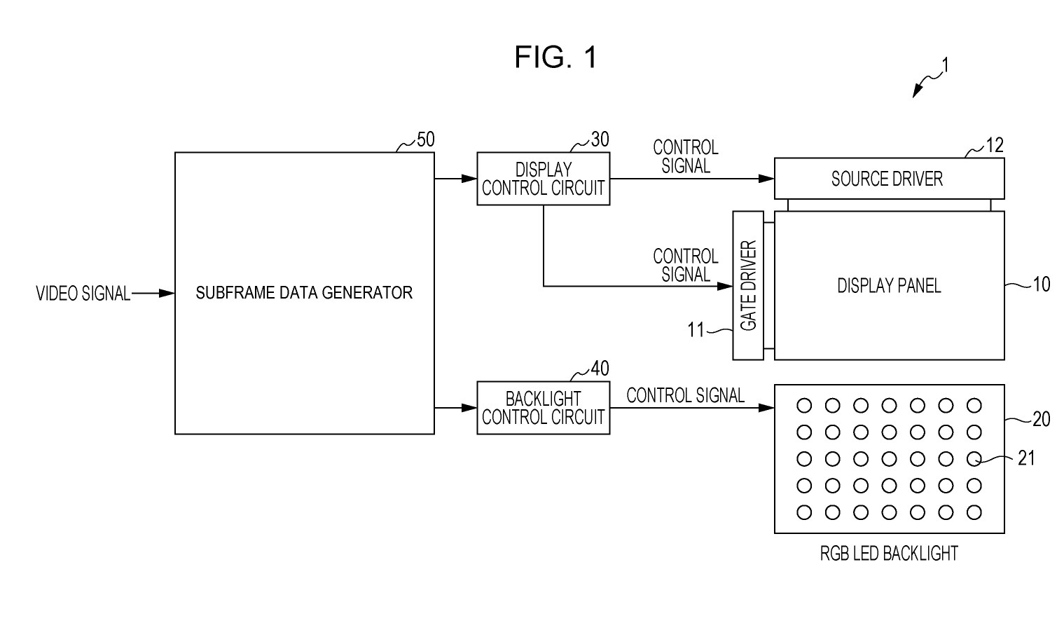

A display apparatus of a first preferred embodiment of the present invention is described in detail with reference to FIG. 1 through FIG. 3.

FIG. 1 is a block diagram illustrating a display apparatus 1 of the first preferred embodiment.

As illustrated in FIG. 1, the display apparatus 1 includes a display panel 10, a gate driver 11, a source driver 12, a backlight (light source) 20, a display control circuit 30, a backlight control circuit 40, and a subframe data generator 50.

The display apparatus 1 receives video signals consecutively from the outside, and displays a video (image) on a display screen of the display panel 10 in response to each video signal.

For convenience of explanation, FIG. 1 illustrates the display panel 10 vertically above the backlight 20. In practice, however, the display panel 10 and the backlight 20 are arranged to face each other.

The display apparatus 1 of the first preferred embodiment may be used as a so-called field sequential driving display apparatus as described below, for example.

The backlight 20 includes a plurality of light sources 21, and the light sources 21 emit light beams to the display panel 10.

The backlight 20 includes a plurality of types of light sources respectively emitting different color light beams. The backlight 20 of the first preferred embodiment preferably includes a red-color light source 21R emitting a red light beam, a green-color light source 21G emitting a green light beam, and a blue-color light source 21B emitting a blue color light beam.

The backlight 20 lights at least one of the light sources 21. By lighting the red-color light source 21R, the backlight 20 emits a red light beam. By lighting the green-color light source 21G, the backlight 20 emits a green light beam. By lighting the blue-color light source 21B, the backlight 20 emits a blue light beam. By lighting the red-color light source 21R, the green-color light source 21G, and the blue-color light source 21B, the backlight 20 emits a white light beam.

The backlight 20 may direct a light beam from the light sources 21 to the display panel 10 directly or via a light guide plate.

The display panel 10 includes a front display screen, and allows light emitted from the backlight 20 to be selectively transmitted therethrough, to display a video on the display screen.

The display panel 10 includes a plurality of data lines (not illustrated), and a plurality of scanning lines (not illustrated) intersecting the data lines. A plurality of pixels is arranged in a matrix such that the pixels are respectively disposed at the intersections of the data lines and the scanning lines.

A TFT is disposed at each pixel as a switching element. A scanning line is connected to the gate electrode of the TFT, and a data line is connected to the source electrode of the TFT. In this way, the source driver and the gate driver control light transmittance at each pixel, thus displaying a video.

A liquid-crystal panel may be used for the display panel 10, for example.

The subframe data generator 50 generates display data (display control signal) to control the display panel 10 and light source data (display control signal) to control the backlight 20 in response to a video signal input from outside the display apparatus 1.

The display data is supplied to the display control circuit 30, and the display control circuit 30 controls light transmittance of each pixel via the source driver and the gate driver in response to the display data. The display data includes video data to be supplied to each pixel in the display panel 10. For example, if the display panel 10 is a liquid-crystal panel, the display data may be in the form of voltage data to be applied to a liquid-crystal layer of each pixel. When a piece of the display data is input to the display control circuit 30, the scanning lines in the display panel 10 are scanned so that a video displayed on the display screen of the display panel 10 is updated once.

The light source data is supplied to the backlight control circuit 40, and the backlight control circuit 40 controls the lighting of the light sources 21 in the backlight 20 in response to the light source data.

The subframe data generator 50 generates a plurality of pieces of display data and a plurality of pieces of light source data to display multiple videos (multiple subframe videos) in response to the inputting of a video signal.

In this way, the multiple subframe videos are displayed on the display screen of the display panel 10 in response to a video signal. The subframe videos are overlaid on the retinas of a viewer of the display apparatus 1 through the residual image effect and are thus recognized as a single video by the viewer.

A non-limiting example of a driving method of the display apparatus 1 of the first preferred embodiment is described below.

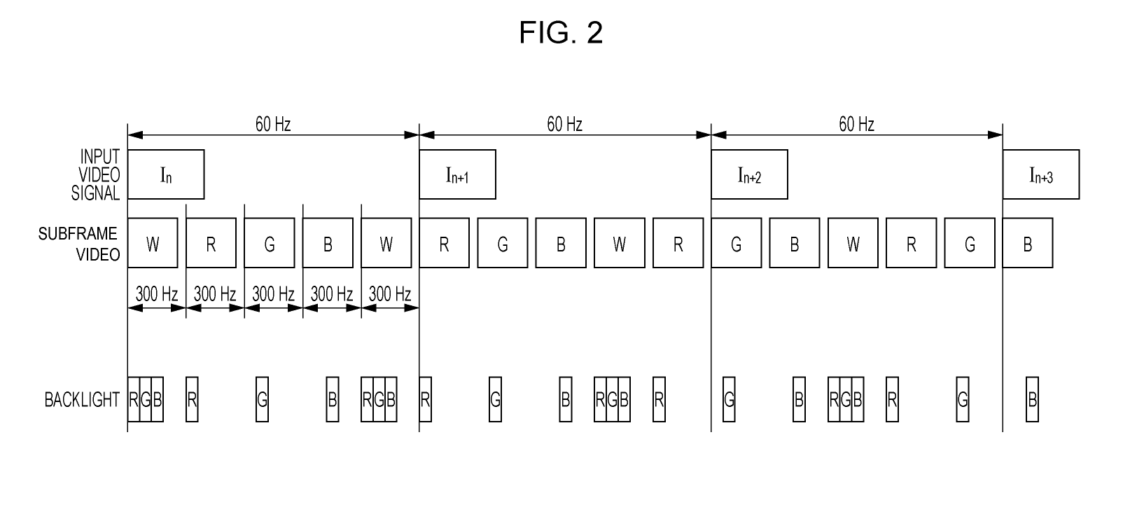

FIG. 2 is a timing diagram illustrating an operation of the display apparatus of the first preferred embodiment.

Referring to FIG. 2, the video signal is consecutively input to the display apparatus 1 at a standard frequency of 60 Hz, namely, with a period of 16.6 ms, for example.

The display apparatus 1 segments the period throughout which two consecutive video signals are input into five subframe periods, and display a subframe video during each subframe period. More specifically, the display apparatus 1 displays five subframe videos in response to a single video signal, thus displaying a video of one frame.

In order to display the five subframe videos in response to a single video signal, the subframe period to which each subframe video is assigned is 3.33 ms (16.6/5 ms), for example. The subframe videos are consecutively updated at 300 Hz, for example. The display panel 10 and the backlight 20 are also controlled at 300 Hz in order to consecutively update the subframe videos at 300 Hz, for example.

To perform the above operation, the subframe data generator 50 generates the display data and the light source data so that the display panel 10 and the backlight 20 are controlled at 300 Hz while being kept in synchronization with each other.

The subframe video includes a white subframe video of white light (hereinafter referred to as W video), a red-color subframe video of red light (hereinafter referred to as R video), a green-color subframe video of green light (hereinafter referred to as G video), and a blue-color subframe video of blue light (hereinafter referred to as B video).

As illustrated in FIG. 2, when the W video is displayed, the backlight 20 causes all the light sources 21, namely, the red-color light source 21R, the green-color light source 21G, and the blue-color light source 21B to light, and thus emits a white light beam therefrom.

When the R video is displayed, the backlight 20 causes only the single red-color light source 21R to light, and thus emits a red light beam therefrom.

When the G video is displayed, the backlight 20 causes only the single green-color light source 21G to light, and thus emits a green light beam therefrom.

When the B video is displayed, the backlight 20 causes only the single blue-color light source 21B to light, and thus emits a blue light beam therefrom.

The viewer of the display apparatus 1 may recognize a video on which the five subframe videos are overlaid, by updating and displaying the subframe videos of the W video, the R video, the G video, and the B video at 300 Hz, for example.

As illustrated in FIG. 2, the display apparatus 1 of the first preferred embodiment decomposes the video signal into the W video, the R video, the G video, and the B video and displays these videos in this order. The display apparatus 1 also displays the five subframes in response to a single video signal.

For this reason, the subframe video of any one type is displayed twice when the video (the video of one frame) is displayed in response to the single video signal. Each of the W video, the R video, the G video, and the B video is displayed five times while the videos of four frames are displayed.

As illustrated in FIG. 2, for example, the video signals consecutively input may now be a first video signal Iₙ, a second video signal Iₙ₊₁, a third video signal Iₙ₊₂, and a fourth video signal Iₙ₊₃. The W video, the R video, the G video, the B video, and the W video are displayed in this order to display the video of one frame in response to the first video signal Iₙ. In this case, the W video is displayed twice.

Similarly, the R video, the G video, the B video, the W video, and the R video are displayed in this order to display the video of one frame in response to the second video signal Iₙ₊₁. The R video signal is displayed twice.

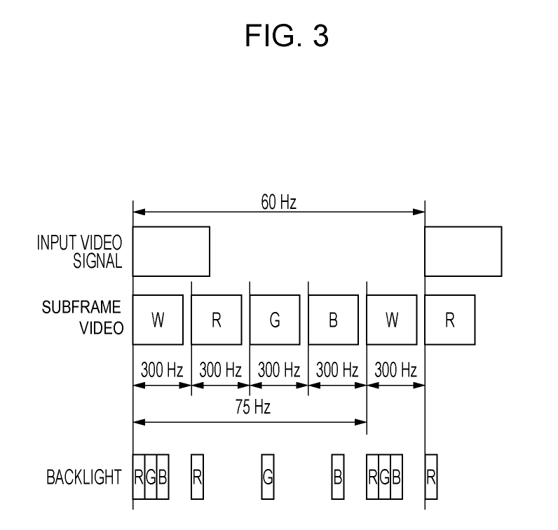

FIG. 3 is a timing diagram illustrating the operation of the display apparatus of the first preferred embodiment.

Since the W video, the R video, the G video, and the B video are displayed in this order one video at a time, the backlight 20 periodically emits the white light beam, the red light beam, the green light beam, and the blue light beam in this order.

When the light emission of a type of color light is periodically repeated by the backlight 20, a lighting period that is a repeated cycle of lighting the same type of color light is 13.3 ms (3.33×4 ms), and is shorter than the period for a cycle of receiving the video signal (16.6 ms), for example.

More specifically, in the case of the red color light, the lighting period of the red color light is 13.3 ms, for example. Similarly, in the case of the green color light, the lighting period of the green color light is 13.3 ms, for example. In the case of the blue color light, the lighting period of the blue color light is 13.3 ms, for example. In the case of the white color light, the lighting period of the white color light is 13.3 ms, for example. In any color light, the lighting period is shorter than the period for the cycle of receiving the video signal (16.6 ms), for example.

If the lighting period of each color light beam in the backlight 20 is converted into a lighting frequency, the lighting frequency is 75 Hz, for example.

If the lighting frequency is 70 Hz or higher, flicker is generally unrecognizable to the viewer.

Since the lighting frequency of the backlight 20 is 75 Hz in the display apparatus 1 of the first preferred embodiment, the occurrence of flicker is controlled. Since the W video is displayed as a subframe video, the color breakup is controlled.

In the above discussion, the number of subframe videos (subframe segmentation number) responsive to a single video signal preferably is five, but the number of subframe videos is not limited to five. The subframe segmentation number may be six or higher. The larger the subframe segmentation number is, the less the flicker occurs. The display period of each subframe video is shorter, and a fast-response display panel is thus needed, leading a cost increase.

### Second Preferred Embodiment

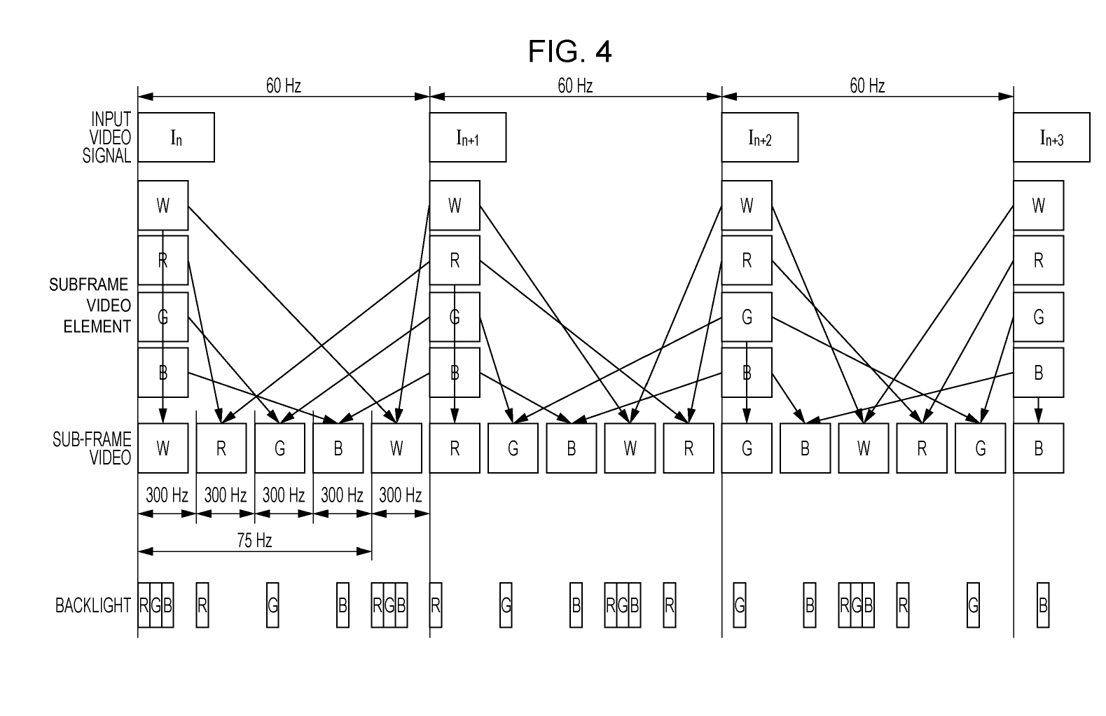

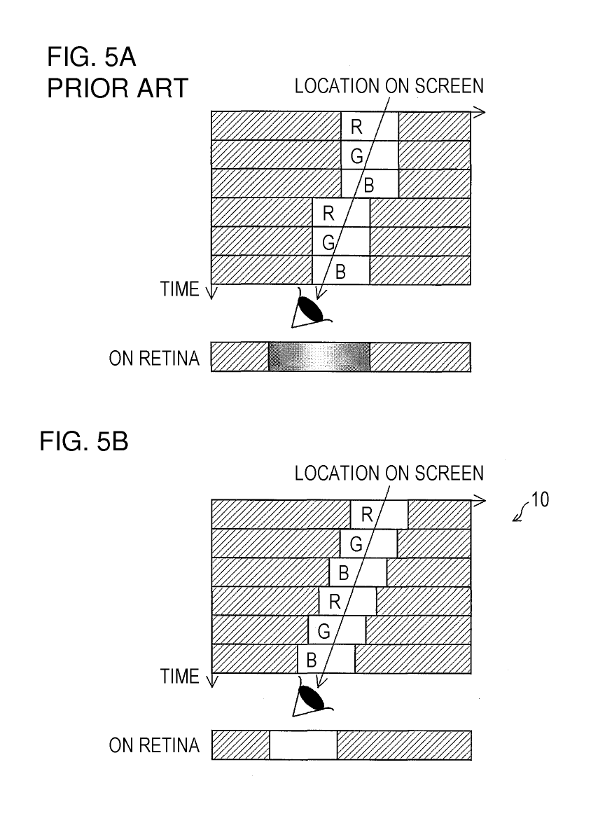

Other preferred embodiments of the present invention are described below with reference to FIG. 4 and FIG. 5. For convenience of explanation, elements having functions identical to those of the first preferred embodiment are designated with the same reference numerals and the discussion thereof is omitted herein.

The display apparatus of a second preferred embodiment includes a subframe data generator that displays subframe videos in response to two consecutively input video signals.

The second preferred embodiment is specifically described with reference to FIG. 4. FIG. 4 is a timing diagram illustrating an operation of the display apparatus of the second preferred embodiment.

Referring to FIG. 4, the subframe data generator generates a subframe video element in response to an input video signal. The subframe video element includes a display data element in a data format identical to a data format of the display data.

In the following discussion, a subframe video element generated in response to the first video signal Iₙ is referred to as a first subframe component, a second subframe video element generated in response to the second video signal Iₙ₊₁ is referred to as a second subframe component, a third subframe video element generated in response to the third video signal Iₙ₊₂ is referred to as a third subframe component, and a subframe video element generated in response to the fourth video signal Iₙ₊₃ is referred to as a fourth subframe component.

From the subframe video element generated in response to the two consecutively input video signals, the subframe data generator generates the display data and the light source data to display each subframe video, on a per color basis at the display timing.

In other words, the subframe data generator corrects the subframe video element generated in response to the video signal, using the subframe video element that is generated in response to the next input video signal, on a per color basis at the display timing. The subframe data generator thus generates the display data and the light source data to display the subframe video.

The generation process of the display data and the light source data is specifically described below.

Firstly, the subframe data generator of the display apparatus of the second preferred embodiment generates the subframe video element in response to the two consecutively input video signals. The generation method of the subframe video element may be a standard method of generating the display data and the light source data corresponding to the subframe video from the video signal. The subframe video element may be obtained by decomposing the video signal into videos of RGBW colors.

Secondly, a motion vector is calculated on a per color basis in the display data element of the subframe video element generated in response to the two consecutively input video signals. More specifically, an amount of movement of an object (hereinafter referred to as a motion vector) in the display data element of the two subframe video elements is calculated as data on a per color basis.

Thirdly, the motion vector is multiplied by a coefficient corresponding to the order in which a subframe video is displayed from among the subframe videos displayed in response to a video signal. A correction value applicable to the display data of each subframe video element is thus determined. For example, when a first subframe video to be displayed is generated from among the subframe videos to be displayed in response to the one video signal, the coefficient by which the motion vector is multiplied may be zero as a correction value. In other words, the correction value is zero with no correction performed in practice. When a second subframe video to be displayed is generated, the coefficient by which the motion vector is multiplied may be 0.2 as a correction value, for example. When a third subframe video to be displayed is generated, the coefficient by which the motion vector is multiplied may be 0.4 as a correction value, for example. When a fourth subframe video to be displayed is generated, the coefficient by which the motion vector is multiplied may be 0.6 as a correction value, for example. When a fifth subframe video to be displayed is generated, the coefficient by which the motion vector is multiplied may be 0.8 as a correction value, for example.

Fourthly, the display data to display the subframe video is generated by applying the determined correction value on the display data element of each the subframe video element on a per color basis.

As illustrated in FIG. 4, first subframe video elements of red, green, blue and white are generated in response to a first video signal, and second subframe video elements of red, green, blue and white are generated in response to a second video signal. Next, a motion vector from the display data element of the first red subframe video element to the display data element of the second red subframe video element is calculated. Since the R video is the second subframe video to be displayed, from among the subframe videos to be displayed in response to the first video signal, the correction value is determined to be (the motion vector)×0.2 as a correction value, for example. Next, the sum of the display data element of the first red subframe video element and the correction value is determined to be the display data to display the R video.

FIGS. 5A and 5B illustrate how an object moving on a display screen is visually recognized by a viewer wherein FIG. 5A illustrates how the object on a field sequential driving display apparatus of the related art is visually recognized by the viewer, and FIG. 5B illustrates how the object is visually recognized by the viewer if position correction of a preferred embodiment of the present invention is applied.

The display apparatus of a preferred embodiment of the present invention displays the W video as the subframe video. Referring to FIG. 5B, the W video is not illustrated to compare with the related art technique.

If a white object moves across a display screen in the related art field sequential driving display apparatus as illustrated in FIG. 5A, afterimages of RGB colors do not overlap properly but deviate from each other on the retinas of the viewer. In this way, the color of a deviated portion is visually recognized as a noise (color breakup).

In contrast, the display apparatus according to a preferred embodiment of the present invention corrects the display data element in response to the timing when the motion vector and the subframe video are displayed, and then displays the subframe video. The color breakup is thus reduced as illustrated in FIG. 5B.

In the above discussion, the subframe video is displayed in response to the two consecutively input video signals. The present invention is not limited to this example. For example, the subframe video is displayed in response to three consecutively input video signals.

### Third Preferred Embodiment

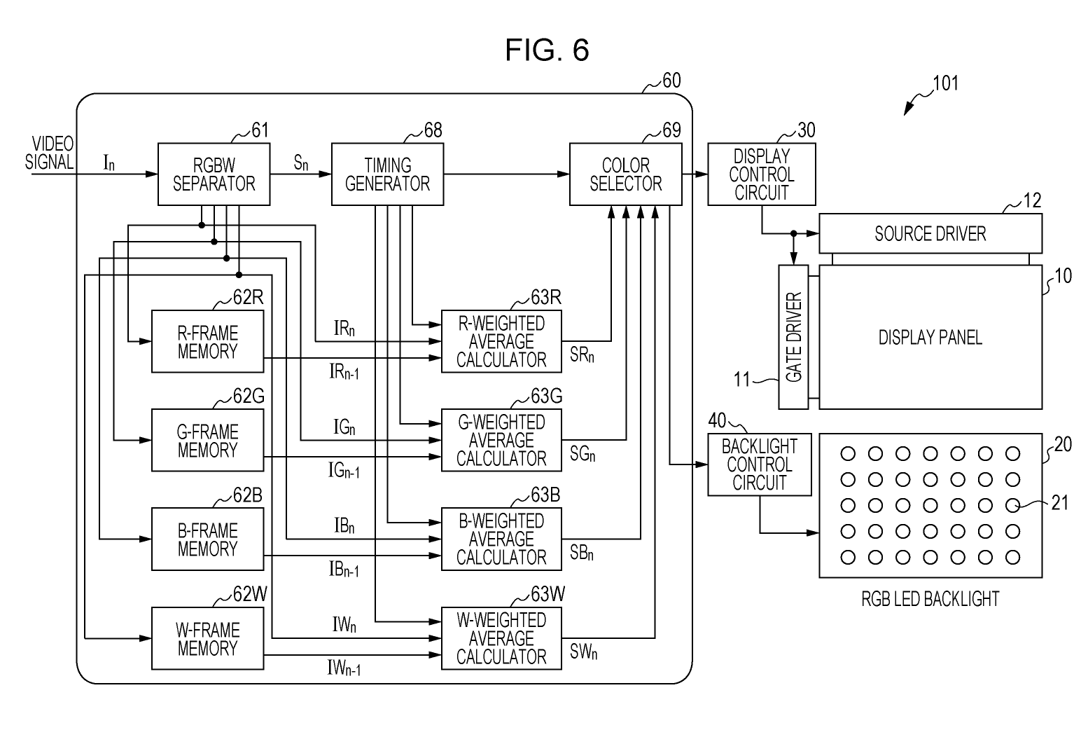

A third preferred embodiment of the present invention is described below with reference to FIG. 6. For convenience of explanation, elements identical in function to the elements described with the above-described preferred embodiments are designated with the same reference numerals and the discussion thereof are omitted.

FIG. 6 is a block diagram illustrating a display apparatus 101 of the third preferred embodiment.

The display apparatus 101 of the present preferred embodiment is different from the display apparatus of the above-described preferred embodiments in that the display apparatus 101 includes a subframe data generator 60.

As illustrated in FIG. 6, the subframe data generator 60 includes an RGBW separator 61, RGBW-frame memories 62R, 62G, 62B, and 62W, RGBW-weighted average calculators 63R, 63G, 63B, and 63W, a timing generator 68, and a color selector 69.

The RGBW separator 61 separates consecutively input video signals Iₙ into a display data element IR of the red subframe video element, a display data element IG of the green subframe video element, a display data element IB of the blue subframe video element, and a display data element IW of the white subframe video signal.

The RGBW separator 61 outputs a seed signal S to the timing generator 68 in synchronization with the input video signal. More specifically, the RGBW separator 61 outputs the 60 Hz seed signal Sₙ to the timing generator 68 in synchronization with the video signal Iₙ consecutively input at 60 Hz.

In response to the seed signal Sₙ, the timing generator generates a timing signal that specifies the timing of displaying each subframe video.

The timing signal is transferred to each of the RGBW-weighted average calculator 63R, 63G, 63B, and 63W. The timing signal is also transferred to the color selector 69.

The RGBW-frame memories 62R, 62G, 62B, and 62W temporarily store the display data of the red, green, and blue subframe video elements. More specifically, the RGBW-frame memories 62R, 62G, 62B, and 62W temporarily store the display data elements of the subframe video elements responsive to the consecutively input video signals, output the stored display data elements of the subframe video elements responsive to a newly input video signal, and then store the display data elements of the new subframe video elements.

In the present preferred embodiment, the RGBW-frame memories 62R, 62G, 62B, and 62W store the display data elements IRₙ₋₁, IGₙ₋₁, IBₙ₋₁, and IWₙ₋₁ of the input subframe video elements until the display data elements IRₙ, IGn, IBₙ, and IWₙ of the subframe video elements are input. When the display data elements IRₙ, IGₙ, IBₙ, and IWₙ of the subframe video elements are input, the RGBW-frame memories 62R, 62G, 62B, and 62W outputs the display data elements IRₙ₋₁, IGₙ₋₁, IBₙ₋₁, and IWₙ₋₁ of the subframe video elements, and instead, stores the display data elements IRₙ, IGn, IBₙ, and IWₙ of the subframe video elements.

The RGBW-weighted average calculator 63R, 63G, 63B, and 63W weighted-average the display data element of the subframe video element of at least one color generated in response to the currently input video signal and the display data element of the subframe video element of that color generated in response to the previously input video signal. The RGBW-weighted average calculator 63R, 63G, 63B, and 63W generate the display data representing the subframe video of that color.

The R-weighted average calculator 63R, for example, weighted-average the display data element of the subframe video element segmented from the current video signal and the display data element of the subframe video element segmented from the previously input video signal, thus generating display data SR responsive to the W video.

The weighted-averaging operation refers to averaging a plurality of elements with weights different from element to element. In a generalized form, the weighted-average operation is defined as w₁*x₁+w₂*x₂+ . . . +wₘ*xₘ where m elements are x₁, x₂, . . . , xₘ and weighted coefficients corresponding thereto are w₁, w₂, . . . , wₘ. Note that the weighted coefficients satisfies the relationship of w₁+w₂+ . . . +wₘ=1.

The R-weighted average calculator 63R of the present preferred embodiment calculates SRₙ=α₁*IRₙ₋₁+α₂*IRₙ based on the display data elements IRₙ and IRₙ₋₁ of the red subframe video elements, thus generating the display data SRₙ responsive to the W video.

The weighted coefficients α₁ and α₂ of the present preferred embodiment are specifically α₁=⅓ and α₂=⅔, for example. The weighted-averaging operation of the present preferred embodiment is performed on each corresponding pixel.

The display data SRₙ, SGₙ, SBₙ, and SWₙ generated by the RGBW-weighted average calculator 63R, 63G, 63B, and 63W are consecutively transferred to the color selector 69 in the order of SRₙ, SGₙ, SBₙ, and SWₙ in response to the timing signal from the timing generator 68.

The color selector 69 selects the display data to be supplied to the display control circuit 30 from the display data responsive to each color in synchronization with the lighting timing of the light source of each color.

More specifically, the color selector 69 selects the display data SRₙ, SGₙ, SBₙ, and SWₙ in response to the timing signal from the timing generator 18, and then consecutively supplies the display data to the display control circuit 30.

The color selector 69 also supplies to the backlight control circuit 40 the light source data of each color that synchronizes with the timing signal from the timing generator 68.

More specifically, the color selector 69 outputs the light source data to light the light source to the backlight control circuit 40 in synchronization with the display data SRₙ, SGₙ, SBₙ, and SWₙ.

Using simple video signal processing, such as the weighted average operation, the display apparatus 101 of the present preferred embodiment reduces the occurrence of the color breakup with a reduced circuit scale. The weighted-average operation is performed on a pixel of interest without reference to the video signals of pixels surrounding the pixel of interest. The weighted-averaging operation of the weighted-average calculator is thus performed at a high speed. Since the weighted-average operation generates a value of each pixel in the driving signal of each color without using the motion vector, the display apparatus 101 is free from image breakup, which could occur in the calculation process using the motion vector.

The display apparatus (1 or 101) of a first aspect of various preferred embodiments of the present invention includes a light source (backlight 20) including a plurality of types of light sources (21) that respectively emit different color light beams, a display panel (10) that displays a video by allowing the color light beams emitted from the light source to be transmitted therethrough, and a subframe data generator (50 or 60) that generates a display control signal that controls an operation of the light source and the display panel in response to video signals (Iₙ) consecutively input from the outside. The subframe data generator segments a period for a cycle of receiving the video signal into a plurality of subframe periods, and generates the display control signal that controls the operation of the light source and the display panel during each subframe period in response to the video signal. In response to the display control signal, the light source periodically alternates between a light beam emitted by one type of the light sources in a subframe period and the light beams emitted by all the types of the light sources in a subsequent subframe period. In view of each type of the color light beams emitted from the light source, a lighting period for a cycle of emission of the same type of color light beams is shorter than the period for the cycle of receiving the video signal.

In the above configuration, the lighting period of the light source is shorter than the input period of the video signal, and the lighting frequency is higher than the input frequency of the video signal. The 60 Hz video signal is input in a normal operation. If a light beam is output at 60 Hz from the light source, there is a possibility that flicker is recognized. If the light source emits the light beam at a frequency higher than the input frequency of the video signal, the occurrence of flicker is controlled.

Since the light source causes all the light sources to light and emit light, the occurrence of the color breakup is controlled.

In the display apparatus of a second aspect of various preferred embodiments of the present invention, in view of the first aspect, the display control signal may include display data that controls the operation of the display panel. The display panel displays a subframe video in response to the display data during each subframe period. The subframe data generator generates the display data based on the video signals consecutively input.

In the display apparatus of a third aspect of various preferred embodiments of the present invention, in view of the second aspect, the subframe data generator may generate the display data at a timing of displaying the subframe video during a period extending between two video signals that are input.

In this configuration, the occurrence of color breakup is even further controlled.

In display apparatus of a fourth aspect of various preferred embodiments of the present invention, in view of the second aspect, the subframe data generator may generate an n-th display data element identical in data format to the display data in response to an n-th input video signal, and an (n+1)-th display data element identical in data format to the display data in response to an (n+1)-th input video signal. The subframe data generator may generate the display data by weighted-averaging the n-th display data element and the (n+1)-th display data element.

In this configuration, the use of a simple video signal process, such as the weighted average operation, reduces the circuit scale while controlling the occurrence of color breakup.

In the display apparatus of a fifth aspect of various preferred embodiments of the present invention, in view of one of the first through fourth aspects, the video signal may be input to the subframe data generator with a period of 1/60 second, and the subframe period may be 1/300 second, for example.

In the display apparatus of a sixth aspect of various preferred embodiments of the present invention, in view of one of the first through fifth aspects, the light source may include a light source (21R) that emits a red light beam, a light source (21G) that emits a green light beam, and a light source (21B) that emits a blue light beam.

According to a seventh aspect of various preferred embodiments of the present invention, there is provided a driving method of a display apparatus including a light source including a plurality of types of light sources that respectively emit different color light beams, and a display panel that displays a video by allowing the color light beams emitted from the light source to be transmitted therethrough. The driving method displays in response to video signals consecutively input from the outside, and includes a control step of segmenting a period for a cycle of receiving the video signal into a plurality of subframe periods, and controlling an operation of the light source and the display panel during each subframe period in response to the video signal. In the control step, the light source periodically alternates between a light beam emitted by one type of the light sources in a subframe period and the light beams emitted by all the types of the light sources in a subsequent subframe period. In view of each type of the color light beams emitted from the light source, the operation of the light source is controlled such that a lighting period for a cycle of emission of the same type of color light beams is shorter than the period for the cycle of receiving of the video signal.

The present invention is not limited to each of the above-described preferred embodiments and aspects. A variety of modifications is possible to the preferred embodiments within the scope defined by the claims. Preferred embodiments resulting from combining technical elements disclosed in the different preferred embodiments are within the scope of the present invention. By combining the technical elements disclosed in the preferred embodiments, a new technical feature may be obtained.

In the driving method of the display apparatus of an eighth aspect of various preferred embodiments of the present invention, in view of the seventh aspect, the control step of generating may include a display data generation step of generating the display data in response to a plurality of video signals consecutively input. The display panel displays the subframe video on each subframe period in response to the display data.

In the driving method of the display apparatus of a ninth aspect of various preferred embodiments of the present invention, in view of the eighth aspect, the display data generation step may include generating the display data at a timing of displaying the subframe video during a period extending between the two consecutively input video signals.

In the driving method of the display apparatus of a tenth aspect of various preferred embodiments of the present invention, in view of the eighth aspect, the display data generation step may include generating an n-th display data element identical in data format to the display data in response to an n-th input video signal, and an (n+1)-th display data element identical in data format to the display data in response to an (n+1)-th input video signal and generating the display data by weighted-averaging the n-th display data element and the (n+1)-th display data element.

In the driving method of the display apparatus of an eleventh aspect of various preferred embodiments of the present invention, in view of one of the seventh through tenth aspects, the video signal may be input to the subframe data generator with a period of 1/60 second, and the subframe period may be 1/300 second, for example.

In the driving method of the display apparatus of a twelfth aspect of various preferred embodiments of the present invention, in view of one of the seventh through eleventh aspects, the light source may include a light source that emits a red light beam, a light source that emits a green light beam, and a light source that emits a blue light beam.

According to various preferred embodiments of the present invention, the field sequential drive method is applicable to a display apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-5. (canceled)

6. A display apparatus comprising:
a light source including a plurality of types of light sources that respectively emit different color light beams;
a display panel that displays a video by allowing the color light beams emitted from the light source to be transmitted therethrough; and
a subframe data generator that generates a display control signal that controls an operation of the light source and the display panel in response to video signals successively input from outside; wherein
the subframe data generator segments a period for a cycle of receiving the video signal into a plurality of subframe periods, and generates the display control signal that controls the operation of the light source and the display panel during each subframe period in response to the video signal;
in response to the display control signal, the light source periodically alternates between a light beam emitted by one type of the light sources in a subframe period and light beams emitted by all types of the light sources in a subsequent subframe period; and
in view of each type of the color light beams emitted from the light source, a lighting period for a cycle of emission of a same type of the color light beams is shorter than a lighting period for a cycle of receiving the video signal but longer than half the period for the cycle of receiving the video signal.

7. The display apparatus according to claim 6, wherein
the display control signal includes display data that controls an operation of the display panel;
the display panel displays a subframe video in response to the display data during each subframe period; and
the subframe data generator generates the display data based on the video signals successively input.

8. The display apparatus according to claim 7, wherein the subframe data generator generates the display data at a timing of displaying the subframe video during a period between two video signals that are input.

9. The display apparatus according to claim 7, wherein
the subframe data generator generates an n-th display data element identical in data format to display data in response to an n-th input video signal, and an (n+1)-th display data element identical in data format to display data in response to an (n+1)-th input video signal;
the subframe data generator generates the display data by weighted-averaging the n-th display data element and the (n+1)-th display data element.

10. The display apparatus according to claim 6, wherein the video signal is input to the subframe data generator with a period of 1/60 second, and a subframe period is 1/300 second.

11. The display apparatus according to claim 6, wherein the light source includes a light source that emits a red light beam, a light source that emits a green light beam, and a light source that emits a blue light beam.

12. A driving method of a display apparatus including a light source including a plurality of types of light sources that respectively emit different color light beams, and a display panel that displays a video by allowing the color light beams emitted from the light source to be transmitted therethrough, the driving method displaying in response to video signals successively input from outside, the method comprising the steps of:
segmenting a period for a cycle of receiving the video signal into a plurality of subframe periods; and
generating a display control signal that controls an operation of the light source and the display panel during each subframe period in response to the video signal; wherein
in response to the display control signal, the light source periodically alternates between a light beam emitted by one type of the light sources in a subframe period and the light beams emitted by all types of the light sources in a subsequent subframe period, and in view of each type of the color light beams emitted from the light source, a lighting period for a cycle of emission of a same type of color light beams is shorter than a period for a cycle of receiving the video signal but longer than half the period for the cycle of receiving the video signal.

13. The driving method of the display apparatus according to claim 12, wherein
the generation step includes a display data generation step of generating the display data in response to a plurality of video signals consecutively input;
the display panel displays the subframe video on each subframe period in response to the display data.

14. The driving method of the display apparatus according to claim 13, wherein the display data generation step includes generating the display data at a timing of displaying the subframe video during a period between the two consecutively input video signals.

15. The driving method of the display apparatus according to claim 13, wherein
the display data generation step includes generating an n-th display data element identical in data format to display data in response to an n-th input video signal, and an (n+1)-th display data element identical in data format to display data in response to an (n+1)-th input video signal; and
generating the display data by weighted-averaging the n-th display data element and the (n+1)-th display data element.

16. The driving method of the display apparatus according to claim 12, wherein the video signal is input to the subframe data generator with a period of 1/60 second, and a subframe period is 1/300 second.

17. The driving method of the display apparatus according to claim 12, wherein the light source includes a light source that emits a red light beam, a light source that emits a green light beam, and a light source that emits a blue light beam.
